(19) United States
(12) Patent Application Publication
(10) Pub. No.: US 2014/0220878 A1
(43) Pub. Date: Aug. 7, 2014

(54) GAS RELEASE DEVICE FOR COATING PROCESS

(71) Applicant: ADPV TECHNOLOGY LIMITED, APIA (WS)

(72) Inventors: Shiezen Steven HUANG, Redondo Beach, CA (US); Ke-Feng LIAO, Central Hong Kong (CN); Wen-Bo LAI, Central Hong Kong (CN); Kwan-Kin CHAN, Central Hong Kong (CN); Sheng LI, Central Hong Kong (CN); Liang MENG, Ningbo City (CN); Jhao-Lung ZENG, Taipei City (TW); Guan-Bi CHEN, Ningbo City (CN)

(73) Assignee: ADPV TECHNOLOGY LIMITED, APIA (WS)

(21) Appl. No.: 14/166,732

(22) Filed: Jan. 28, 2014

(30) Foreign Application Priority Data
Feb. 5, 2013 (TW) 102104443

(51) Int. Cl. B05B 1/34

(52) U.S. Cl. CPC B05B 1/34
USPC 454/284

(57) ABSTRACT

A gas release device for a coating process includes an upper plate, a first intermediate plate, a second intermediate plate, and a lower plate, four of which are superposed on each other from top to bottom. The upper plate is linked and communicates with the first intermediate plate through a first passage. The first intermediate plate is linked and communicates with the second intermediate plate through at least two second passages. The second intermediate plate is linked with the lower plate through at least four third passages. The lower plate includes at least four ventholes. In light of this, after a gas of a vapor deposition source enters the inlet, the gas of the same amount can be released out of each venthole to make the thickness of a thin film uniform for relatively higher quality of the coating process.

### BACKGROUND OF THE INVENTION

1. Field of the Invention

The present invention relates generally to a coating process and more particularly, to a gas release device for a coating process.

2. Description of the Related Art

The so-called vacuum coating process is to put a workpiece, such as a substrate, into a vacuum chamber and then heat a vapor deposition source, such as selenium, to make it vaporized and sublimated to further make the gas of the vapor deposition source attached to the surface of the workpiece for forming a thin film on the surface of the workpiece.

However, during the current coating process, it is necessary to wait until the gas of the vapor deposition source is attached to the surface of the workpiece on its own, so it is quite time-consuming. Besides, the thickness of the thin film formed on the surface of the workpiece is subject to nonuniformity to further adversely affect the quality of the thin film formed by the coating process.

### SUMMARY OF THE INVENTION

The primary objective of the present invention is to provide a gas release device which can enhance uniformity of thickness of a thin film to lead to a high-quality coating process.

The foregoing objective of the present invention is attained by the gas release device formed of an upper plate, a first intermediate plate, a second intermediate plate, and a lower plate. The second intermediate plate is superposed on a top side of the lower plate. The first intermediate plate is superposed on a top side of the second intermediate plate. The upper plate is superposed on a top side of the first intermediate plate. The upper plate includes an inlet running through a top side thereof and a bottom side thereof, and a distribution groove communicating with a bottom end of the inlet. The first intermediate plate includes a first top groove linked and communicating with the distribution groove of the upper plate, at least two first distribution holes running through the top side thereof and a bottom side thereof and communicating with the first top groove, and at least two first bottom grooves communicating with the at least two first distribution holes, respectively. The second intermediate plate includes at least two second top grooves linked and communicating with the at least two first bottom grooves, respectively, at least two second distribution holes running through the top side thereof and a bottom side thereof and communicating with each of the at least two second top grooves, and at least two second bottom grooves communicating with each of the at least two second distribution holes. The lower plate includes at least four terminal grooves linked and communicating with the at least four second bottom grooves, respectively, and a plurality of ventholes running through the top side thereof and a bottom side thereof and communicating with the at least four terminal grooves. In light of this, the paths between the inlet of the upper plate and the respective ventholes of the lower plate have the same length to make substantially equal amount of a gas of a vapor deposition source released out of each venthole, after the gas enters the distribution groove, to effectively uniform the thickness of the thin film for relatively higher quality of the coating process.

### BRIEF DESCRIPTION OF THE DRAWINGS

FIG. 1 is a perspective view of a preferred embodiment of the present invention, illustrating the inlet of the upper plate.

FIG. 2 is another perspective view of the preferred embodiment of the present invention, illustrating the ventholes of the lower plate.

FIG. 3 is an exploded view of the preferred embodiment of the present invention.

FIG. 4 is a sectional view of the preferred embodiment of the present invention.

### DETAILED DESCRIPTION OF PREFERRED EMBODIMENTS

Structural features and desired effects of the present invention will become more fully understood by reference to a preferred embodiment given hereunder. However, it is to be understood that the embodiment is given by way of illustration only, thus is not limitative of the claim scope of the present invention.

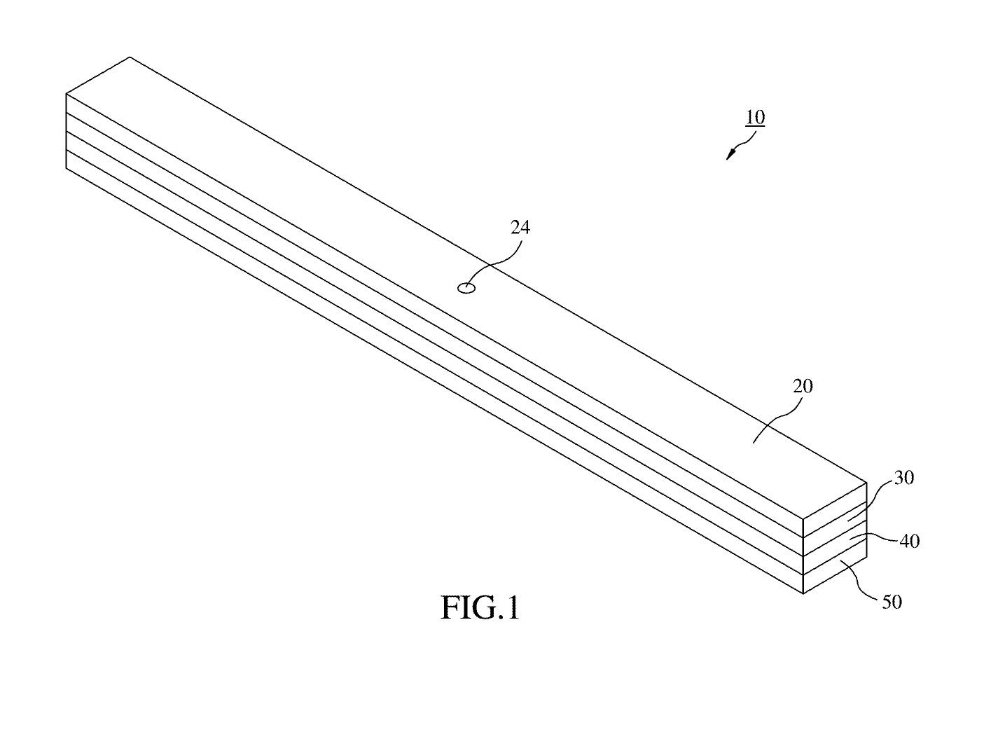

Referring to FIGS. 1-3, a gas release device 10 constructed according to a preferred embodiment of the present invention is applied to a vacuum coating process. The gas release device 10 can be applied to either of coating processes under the environment of other gases as it actually depends. The gas release device 10 is formed of an upper plate 20, a first intermediate plate 30, a second intermediate plate 40, and a lower plate 50, each of which is a rectangular member made of a refractory and corrosion-resistant material. The detailed descriptions and operations of these elements as well as their interrelations are recited in the respective paragraphs as follows.

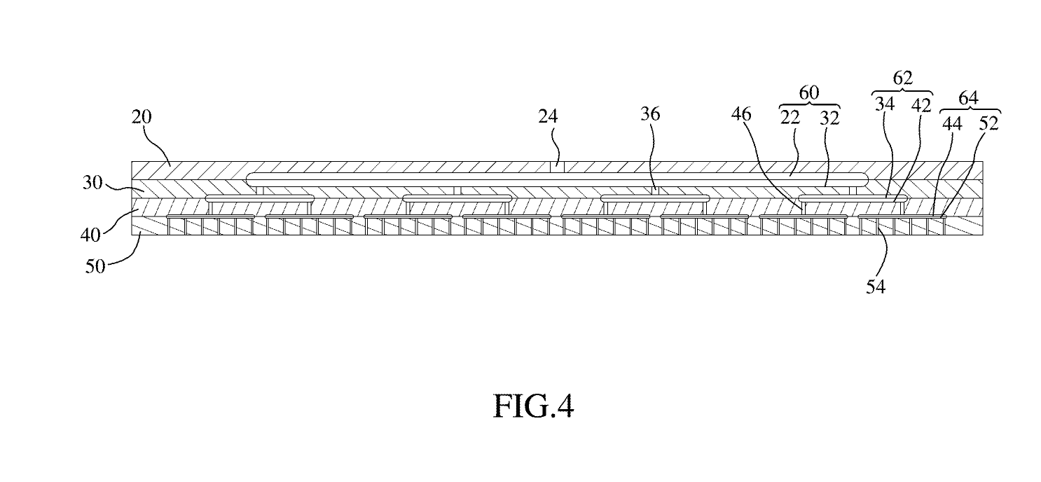

Referring to FIG. 4, the upper plate 20 includes a distribution groove 22 and an inlet 24 running through a top side thereof and a bottom side thereof. The distribution groove 22 is located at the bottom side of the upper plate 20 and communicating with a bottom end of the inlet 24. The distribution groove 22 is provided with a semi-circular cross-section in this preferred embodiment. However, the cross-section of the distribution groove 22 is not limited to the semi-circular figure and can be a rectangular figure or either of other geometric figures. In addition, the inlet 24 is provided with a circular cross-section in this preferred embodiment. However, the cross-section of the inlet 24 is not limited to the circular figure and can be a rectangular figure or either of other geometric figures.

The first intermediate plate 30 includes a first top groove 32, four first distribution holes 36, and four bottom grooves 34. The four first distribution holes 36 are arranged equidistantly and run through a top side and a bottom side of the first intermediate plate 30. The first top groove 32 communicates with the four bottom grooves 34 through the four first distribution holes 36, respectively. Each of the first top groove 32 and the first bottom grooves 34 is provided with a semi-circular cross-section in this preferred embodiment. However, each of the cross-sections of the first top groove 32 and the first bottom grooves 34 is not limited to the semi-circular figure and can be a rectangular figure or either of other geometric figures. Each of the first distribution holes 36 is provided with a circular cross-section in this preferred embodiment. However, the cross-sections of each first distribution hole 36 is not limited to the circular figure and can be a rectangular figure or either of other geometric figures. In addition, the diameter of the first top groove 32 is equal to that of each distribution groove 22 and lager than that of each first bottom groove 34. Each of the first distribution holes 36 is smaller than the inlet 24 in diameter.

The second intermediate plate 40 includes four second top grooves 42, eight second distribution holes 46, and eight second bottom grooves 44. The eight second distribution holes 46 are arranged equidistantly and run through a top side and a bottom side of the second intermediate plate 40. Each two of the eight second distribution holes 46 communicate with one of the second top grooves 42. Each of the second top grooves 42 and the second bottom grooves 44 is provided with a semi-circular cross-section in this preferred embodiment. However, each of the cross-sections of the second top and bottom grooves 42 and 44 is not limited to the semi-circular figure and can be a rectangular figure or either of other geometric figures. Each of the second distribution holes 46 is provided with a circular cross-section in this preferred embodiment. However, the cross-section of each second distribution hole 46 is not limited to the circular figure and can be a rectangular figure or either of other geometric figures. In addition, the diameter of each second top groove 42 is equal to that of either of the first bottom grooves 34 and larger than that of either of the second bottom grooves 44. Each of the second distribution holes 46 is smaller than either of the first distribution holes 36 in diameter.

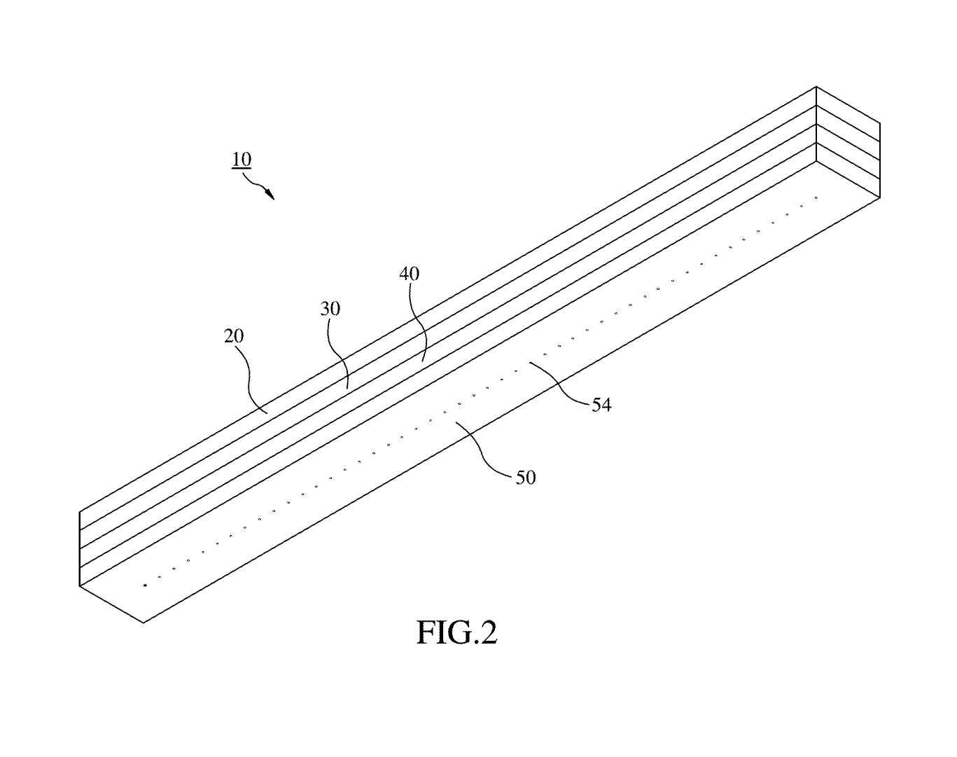

The lower plate 50 includes eight terminal grooves 52. Each of the terminal grooves 52 communicates with six ventholes 54 arranged equidistantly. Each of the ventholes 54 runs through a top side and a bottom side of the lower plate 50, as shown in FIGS. 2 and 4. Each of the terminal grooves 52 is provided with a semi-circular cross-section in this preferred embodiment. However, the cross-section of each terminal groove 52 is not limited to the semi-circular figure and can be a rectangular figure or either of other geometric figures. In addition, the diameter of each terminal groove 52 is equal to that of either of the second bottom grooves 44. Each of the ventholes 54 is smaller than either of the second distribution holes 46 in diameter.

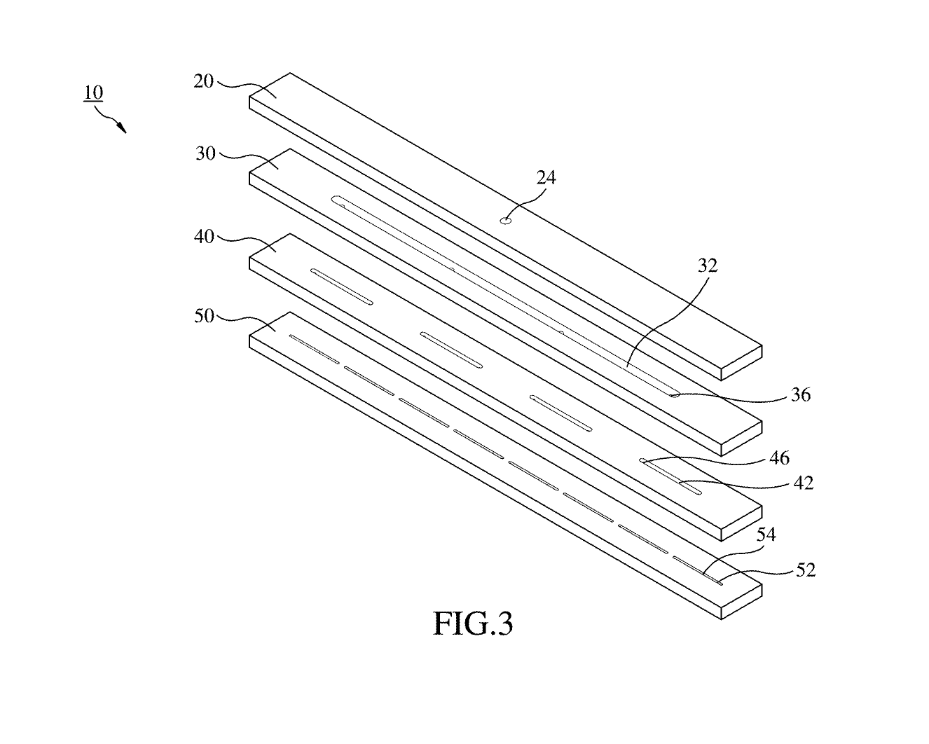

In assembly, referring to FIGS. 3 and 4 again, the second intermediate plate 40 is superposed on the top side of the lower plate 50 to make each of the second bottom grooves 44 linked and communicate with one of the terminal grooves 52, so eight third passages 64 are formed. Next, the first intermediate plate 30 is superposed on the top side of the second intermediate plate 40 to make the first bottom groove 34 linked and communicate with each of the second top grooves 42, so four second passages 62 are formed. At last, the upper plate 22 is superposed on the top side of the first intermediate 30 to make the distribution groove 22 linked and communicate with the first top groove 32, so a first passage 60 is formed.

In light of the structure mentioned above, when the gas of the vapor deposition source enters the first passage 60 through the inlet 24, the gas is averagely distributed by the first distribution holes 36 to enter the second passages 62; next, the gas is further distributed by the second distribution holes 46 to enter the third passages 64; and finally, the gas is released through the ventholes 54 to a surface of a workpiece (not shown).

During the whole process, the first passage 60, the second passages 62, and the third passages 64 are an arithmetic series in number and arranged equidistantly. The inlet 24, the first distribution holes 36, the second distribution holes 46, and the ventholes 54 are also an arithmetic series in number and arranged equidistantly. In light of this, the length of the path between the inlet 24 and each of the ventholes 54 is equal to one another. In this way, the amount of the gas of the vapor deposition source released out of the ventholes 54 is approximately the same, so a film of uniform thickness is formed on the surface of the workpiece. Therefore, the present invention can effectively enhance the quality and efficiency of the coating process.

What is claimed is:

1. A gas release device for a coating process, comprising a lower plate, a second intermediate plate superposed on the lower plate, a first intermediate plate superposed on the second intermediate plate, and an upper plate superposed on the first intermediate plate, wherein:
the upper plate has an inlet and a distribution groove, the inlet running through a top side and a bottom side of the upper plate, the distribution hole communicating with a bottom end of the inlet;
the first intermediate plate has a first top groove, at least two first distribution holes, and at least two first bottom grooves, the first top groove being linked and communicating with the distribution groove and the at least two first distribution holes, the at least two first distribution holes running through a top side and a bottom side of the first intermediate plate, each of the at least two first distribution holes communicating with one of the at least two first bottom grooves;
the second intermediate plate has at least two second top grooves, at least four second distribution holes, and at least four second bottom grooves, the at least four second distribution holes running through a top side and a bottom side of the second intermediate plate, each of the at least two second top grooves being linked and communicating with one of the first bottom grooves;
the lower plate has at least four terminal grooves and a plurality of ventholes, each of the terminal grooves being linked and communicating with one of the at least four second bottom grooves and the ventholes, the ventholes running through a top side and a bottom side of the lower plate.

2. The gas release device as defined in claim 1, wherein each of the inlet, the first distribution holes, the second distribution holes, and the ventholes is provided with a circular cross-section.

3. The gas release device as defined in claim 2, wherein the inlet is larger than either of the first distribution holes in diameter, each of the first distribution holes is larger than either of the second distribution holes in diameter, and each of the second distribution holes is larger than either of the ventholes in diameter.

4. The gas release device as defined in claim 1, wherein each of the distribution groove, the first top groove, the first bottom grooves, the second top grooves, the second bottom grooves, and the terminal grooves is provided with a semi-circular cross-section.

5. The gas release device as defined in claim 4, wherein the distribution hole is equal to the first top groove in diameter, the firs top groove is larger than the first bottom grooves in diameter, each of the first bottom grooves is equal to either of the second top grooves in diameter, each of the second top grooves is larger than either of the second bottom grooves in diameter, and each of the second bottom grooves is equal to either of the terminal grooves in diameter.

6. The gas release device as defined in claim 1, wherein each of the respective numbers of the first distribution hole, the first bottom grooves, and the second top grooves are four; each of the respective numbers of the second distribution holes, the second bottom grooves, the terminal grooves is eight.

7. The gas release device as defined in claim 6, wherein the ventholes communicating with each of the terminal grooves are six in number.
